(19) United States
(12) Patent Application Publication
(10) Pub. No.: US 2013/0307772 A1
(43) Pub. Date: Nov. 21, 2013

(54) INTERACTIVE PROJECTION SYSTEM WITH LIGHT SPOT IDENTIFICATION AND CONTROL METHOD THEREOF

(71) Applicant: BEI-FONG WU, TAOYUAN COUNTY (TW)

(72) Inventor: BEI-FONG WU, TAOYUAN COUNTY (TW)

(73) Assignee: EVEREST DISPLAY INC., HSINCHU CITY (TW)

(21) Appl. No.: 13/589,540

(22) Filed: Aug. 20, 2012

(30) Foreign Application Priority Data
May 21, 2012 (TW) 101118013

(51) Int. Cl. G06F 3/033

(52) U.S. Cl. 345/158

(57) ABSTRACT

The present invention discloses an interactive projection system with light spot identification, including M pointing devices and a projector, and a control method thereof. A light emitting module of each pointing device selectively generates an infrared light spot, and generates an infrared lighting spot status signal corresponded to the operating status of the light emitting module. A wireless signal transmission module of each pointing device transmits a wireless signal including an identification code and the infrared lighting spot status signal. An infrared light spot capturing module of the projector is used to capture an image indicating the infrared light spot projected on a screen. The interactive projection system correspondingly displays movement tracks in order of the infrared light spots on a monitor according to the image and the wireless signals from the M pointing devices, wherein M is a positive integer and greater than or equal to 1.

### BACKGROUND OF THE INVENTION

1. Field of the Invention

The present invention relates to a projection system and control method thereof; in particular, to an interactive projection system with light spot identification and control method thereof.

2. Description of Related Art

With a briefing program, users can edit and store their brief data in a computer host in advance, and the brief data can be projected on a screen by a projector coupled to the computer host.

In traditional, in order to let audience understand the brief data easily, presenter can mark specific words or areas on the screen by using a laser pointer. However, a laser spot generated by the laser pointer moves so fast that the laser spot projected on the screen might disappear before the audience notice the specific words or areas.

Besides, if the brief data is presented by two or more presenter or the brief is configured to discuss or interact between the presenter and the audience, it might need more than two laser pointer used by presenters or audience. In this case, there might be two laser spots projected on the screen at the same time that the other audience might not be able to distinguish the two laser spots, and it is difficult to tell which laser spot represents the presenter or the audience. Moreover, when two or more laser pointer are used in the brief, it is not easy for the audience to assimilate every the specific words or areas marked by different laser pointers, and the brief time will be longer due to inefficiency.

Therefore, an interactive projection system with light spot identification is needed so that the computer host can identify two or more different light spots projected on the screen and response to the light spots, respectively.

### SUMMARY OF THE INVENTION

The object of the present invention is to provide an interactive projection system with light spot identification and a control method thereof. Each of pointing devices of the interactive projection system has an unique identification code so that more than one pointing devices can be used in the interactive projection system at the same time, and movement tracks of infrared light spots emitted by the pointing devices can be calculated after capturing images of the infrared light spots projected on the screen. Therefore, more than one pointing devices can be used in the interactive projection system, and a computer host can identify two or more different infrared light spots projected on the screen and response to the infrared light spots, respectively.

In order to achieve the aforementioned objects, according to an embodiment of the present invention, an interactive projection system with light spot identification is presented, the interactive projection system with light spot identification comprises M pointing devices, a projector, and a wireless signal receiving device. Each of the M pointing devices comprises a light emitting module and a wireless signal transmission module. The light emitting module selectively generates an infrared light spot, and generates an infrared lighting spot status signal corresponded to operating status of the light emitting module. The wireless signal transmission module transmits a wireless signal including an identification code and the infrared lighting spot status signal. The projector comprises a projecting module and an infrared light spot capturing module. The projecting module receives an image signal of a computer host, and projects a projection image on a screen according to the image signal. The infrared light spot capturing module captures at least one image of the infrared light spot projected on the screen. The wireless signal receiving device, coupled to the computer host, receives the wireless signal of each of the M pointing devices. The interactive projection system correspondingly displays movement tracks of the infrared light spots according to the image of the infrared light spot projected on the screen and the wireless signal of each of the M pointing devices, M is a positive integer greater than or equal to 1.

In order to achieve the aforementioned objects, according to an embodiment of the present invention, a control method of an interactive projection system with light spot identification is presented, the control method comprises the following steps: projecting a projection image according to an image signal; generating an infrared lighting spot status signal corresponded to operating status of the light emitting module of the pointing device; generating a wireless signal including an identification code of the pointing device and the infrared lighting spot status signal; capturing at least one image of the infrared light spot projected on the screen; and displaying movement tracks of the infrared light spots according to the image of the infrared light spot projected on the screen and the wireless signal.

To sum up, according to the embodiment of the present invention, each of pointing devices of the interactive projection system has an unique identification code so that the computer host can tell one infrared light spot from another, and movement tracks of infrared light spots emitted by the pointing devices can be calculated after capturing images of the infrared light spots projected on the screen. Besides, each of the infrared light spots can be processed by the computer host, respectively, so that the interactive projection system can be applied in multiple light spots interaction, thus the practicality of the interactive projection system is increased correspondingly.

In order to further the understanding regarding the present invention, the following embodiments are provided along with illustrations to facilitate the disclosure of the present invention.

### BRIEF DESCRIPTION OF THE DRAWINGS

FIG. 1 shows a system operation diagram of an interactive projection system with light spot identification according to an embodiment of the present invention;

FIG. 2 shows a block diagram of the interactive projection system with light spot identification according to an embodiment of the present invention;

FIG. 3A shows a diagram of infrared light spots moving on the screen according to an embodiment of the present invention;

FIG. 3B shows a diagram of the movement of infrared light spots displayed as an image signal within a computer host according to an embodiment of the present invention;

FIG. 4 shows a block diagram of the interactive projection system with light spot identification according to another embodiment of the present invention;

FIG. 5A shows a diagram of infrared light spots moving on the screen according to another embodiment of the present invention;

FIG. 5B shows a diagram of the movement of infrared light spots displayed as an image signal within a computer host according to another embodiment of the present invention;

FIG. 6 shows a flowchart of a control method of the interactive projection system with light spot identification according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

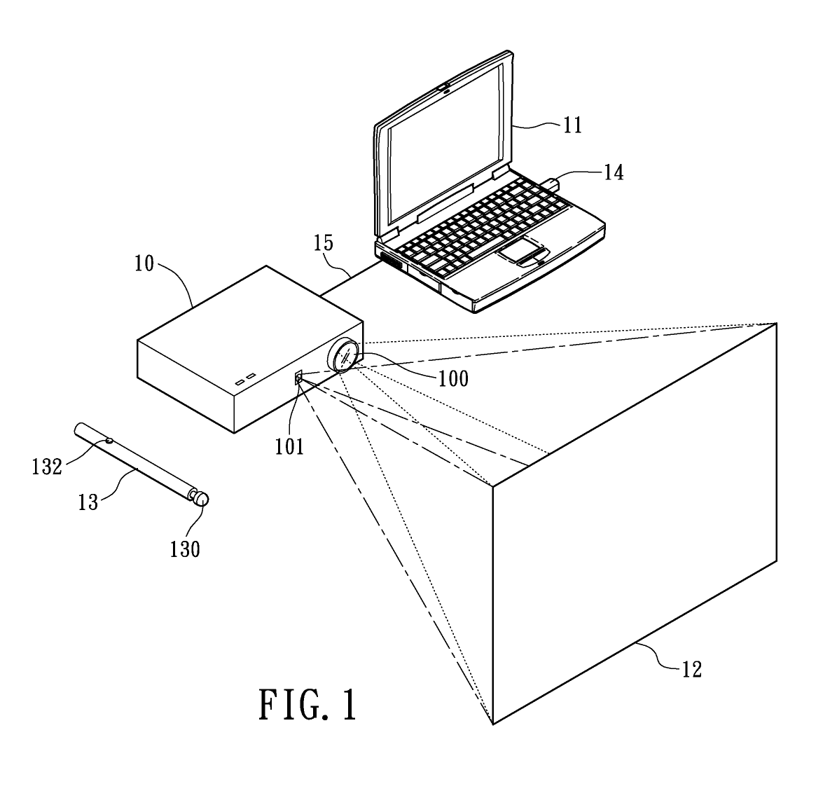

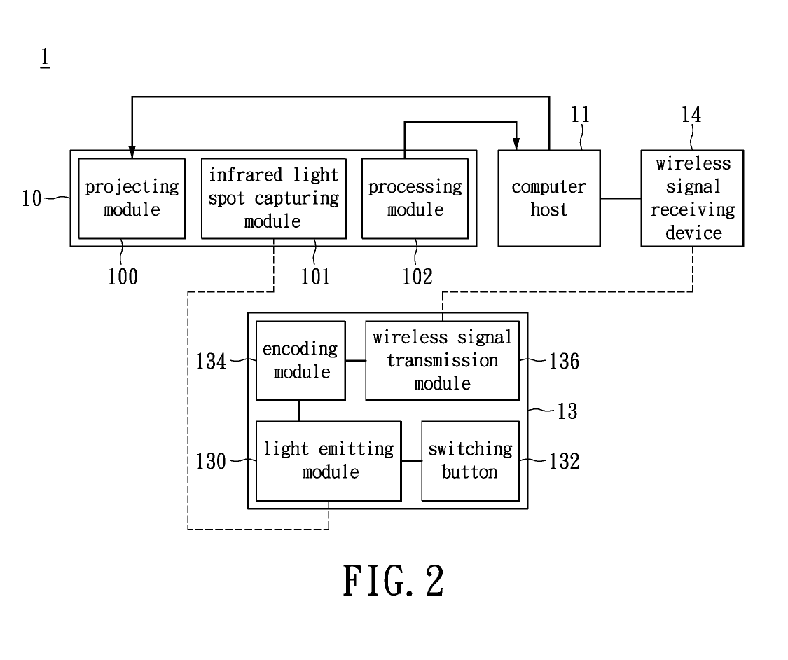

Please refer to FIG. 1 and FIG. 2, FIG. 1 shows a system operation diagram of an interactive projection system with light spot identification according to an embodiment of the present invention, and FIG. 2 shows a block diagram of the interactive projection system with light spot identification according to an embodiment of the present invention. As shown in FIG. 1 and FIG. 2, the interactive projection system with light spot identification 1 includes a projector 10, a computer host 11, a screen 12, a pointing device 13, and a wireless signal receiving device 14. Despite electrically connected to the wireless signal receiving device 14, the computer host 11, such as a personal computer or a notebook, also communicates with the projector 10 through a communication cannel 15. Thus, an image signal stored in a computer host 11 can be projected on the screen 12 to display a projection image via the projector 10.

In general, the screen 12 is usually disposed in front of a light emitter of the projector 10, and a projected area of the screen 12 is basically white so that the projection image projected by the projector 10 can be seen clearly. To be noted, although the screen 12 is not illustrated in FIG. 2, it does not construe that the screen 12 is not needed in the interactive projection system with light spot identification 1. In contrast, the screen 12 should be considered as any objected that the projection image can be projected onto. Besides, the contour of the pointing device 13 can be designed as a pen or a stick which can be easily hold by a user, and a light emitting module 130, disposed on one end of the pointing device 13, can generate infrared light, which can not be seen by bare eyes, when the user presses a switching button 132. Moreover, although FIG. 1 only shows one pointing device 13 used in the interactive projection system with light spot identification 1, there can be, but not limited to, a plurality of pointing devices 13.

Specifically speaking, the communication cannel 15 which is shown in FIG. 1 can be, but not limited to, a wired cable, the communication cannel 15 of the present invention could also utilize wireless communication technique to transmit data between the computer host 11 and the projector 10.

As shown in FIG. 2, the projector 10 has a projecting module 100, an infrared light spot capturing module 101, and a processing module 102. The projecting module 100 receives the image signal of the computer host 11 and projects the projection image on the screen 12 according to the image signal. In practice, the image signal of the computer host 11 can also be displayed by LCD (liquid crystal display), CRT (cathode ray tube), or any suitable displayer. Of course, the computer host 11 may not need any displayer but directly displays the image signal via the projector 10.

The infrared light spot capturing module 101 is used for capturing at least one image of the infrared light projected on the screen 12 which is directed to at least one infrared light spot. In practice, the infrared light spot capturing module 101 is usually disposed on the same side as the light emitter of the projector 10, and the image captured by the infrared light spot capturing module 101 substantially covers the screen 12 so that the infrared light spot projected on the screen 12 can be fully monitored. For example, the infrared light spot capturing module 101 can be, not limited to, CCD (charge coupled device), CMOS (complementary metal oxide semiconductor), or any suitable image capturing device.

Besides, the infrared light spot capturing module 101 can capture the image of the infrared light spot with 0.75 μm˜1.4 μm wavelength (near-infrared, NIR) or the image with 1.4 μm˜3 μm wavelength (far-infrared, FIR).

To be noted, the image captured by the infrared light spot capturing module 101 shall not be limited to the infrared light spot directly projected on the screen 12, but all infrared light sources/spots appeared between the infrared light spot capturing module 101 and the screen 12 (such as the area within chain lines in FIG. 1) can be virtually considered as the infrared light spots projected on the screen 12.

The processing module 102 calculates the coordinates of the infrared light spot projected on the screen 12 according to the images of the infrared light spot captured by the infrared light spot capturing module 101. In practice, the processing module 102 can sequentially calculate a plurality of coordinates of the infrared light spot according to the images recorded by the infrared light spot capturing module 101 within a time interval, and each of the coordinates are corresponded to one specific recording time. To be noted, if two or more infrared light spots are also recorded in the images within the time interval, the coordinates corresponded to each infrared light spot can also be calculated. The coordinates generated by the processing module 102 are transmitted to the computer host 11 for further use.

The pointing device 13 includes at least one light emitting module 130, at least one switching button 132, an encoding module 134, and a wireless signal transmission module 136. The light emitting module 130 is controlled by the switching button 132 disposed on the external surface of the pointing device 13. When the switching button 132 is triggered, the light emitting module 130 generates infrared light accordingly, and the light emitting module 130 also outputs an infrared lighting spot status signal in response to the emission of the infrared light. In other words, when the switching button 132 is triggered, the voltage provided to the light emitting module 130 turns high, so that the light emitting module 130 is conducted, and the infrared lighting spot status signal which indicates the light emitting module 130 is enabled can be transmitted correspondingly. When the switching button 132 is not triggered, the voltage provided to the light emitting module 130 turns low, so that the light emitting module 130 is not conducted, and the infrared lighting spot-status signal which indicates the light emitting module 130 is disabled can be transmitted correspondingly.

To be noted, each pointing device 13 can be designated an identification code which is substantially unique or not likely to be re-designated again, and the encoding module 134 can combine the identification code and the infrared lighting spot status signal to generate a wireless signal. The wireless signal can be received by the wireless signal transmission module 136 and wirelessly transmitted to the wireless signal receiving device 14. In practice, the wireless signal is a radio frequency signal, and its frequency can be, but not limited to, 30 KHz˜300 KHz, 300 KHz˜3 MHz, 3 MHz˜30 MHz, or other legal frequency bands.

The wireless signal receiving device 14 receives the wireless signal wirelessly transmitted from the wireless signal transmission module 136, and outputs the received wireless signal to the computer host 11. In practice, the wireless signal receiving device 14 can be a USB dongle connected to an USB port of the computer host 11, and the wireless signal can be transmitted between the wireless signal receiving device 14 and the computer host 11 via the USB port. For those skilled in the art can easily understand that certain wireless module can be embedded inside the computer host 11 to realize the same function as the wireless signal receiving device 14 of the present invention, thus the wireless signal receiving device 14 should not be limited to the USB dongle.

In an operating embodiment, when the projecting module 100 receives the image signal of the computer host 11 and projects the projection image on the screen 12 according to the image signal, the user can press the switching button 132 to control the light emitting module 130 for emitting infrared light accordingly and outputting the infrared lighting spot status signal. And then, the encoding module 134 generates the wireless signal incorporating the identification code and the infrared lighting spot status signal. And then, the wireless signal transmission module 136 transmits the wireless signal to the wireless signal receiving device 14. After receiving the wireless signal, the wireless signal receiving device 14 passes the wireless signal to the computer host 11. At the same time, the infrared light spot capturing module 101 captures the images of the infrared light projected on the screen 12. And then, the processing module 102 calculates the precise location, such as coordinates, of the infrared light spot relative to the screen 12, and transmits the coordinates with time information to the computer host 11 sequentially and individually.

As mentioned above, the computer host 11 can further recognize which pointing device 13 that the recorded infrared lighting spot belongs to in accordance with the identification code. Meanwhile, the computer host 11 can calculate movement tracks of the infrared light spots according to the coordinates and the corresponding infrared lighting spot status signal, so that the movement tracks of the infrared light spots can be displayed on the modified projection image.

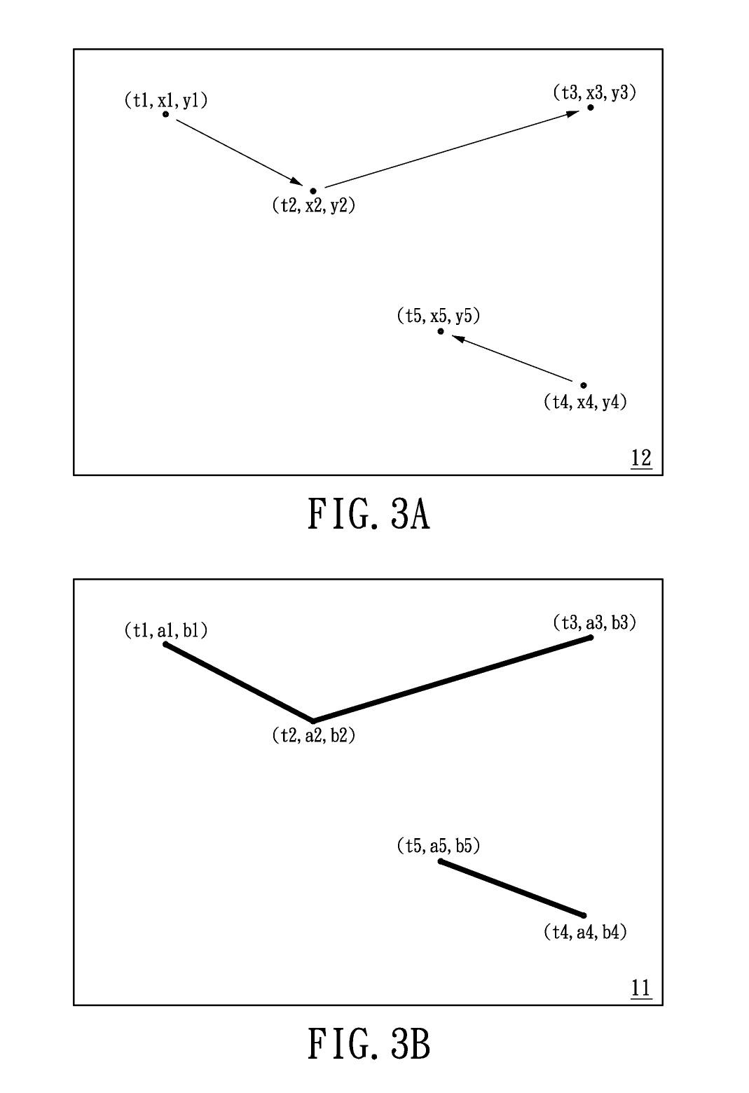

Please refer to FIG. 3A and FIG. 3B, FIG. 3A shows a diagram of infrared light spots moving on the screen according to an embodiment of the present invention, and FIG. 3B shows a diagram of the movement of infrared light spots displayed as an image signal within a computer host according to an embodiment of the present invention. As shown in FIG. 3A and FIG. 3B, when the infrared light spot appears at point (x1,y1) at sampling time t1, the computer host 11 receives the wireless signal and the calculated coordinate indicating point (x1,y1), and displays one spot at point (a1,b1) on the modified projection image. And then, when the infrared light spot appears at points (x2,y2) and (x3,y3) at sampling time t2 and t3, respectively, the computer host 11 receives the wireless signal and the calculated coordinates indicating point (x2,y2) and (x3,y3), and sequentially displays two spots at points (a2,b2) and (a3,b3) on the modified projection image. Since the computer host 11 can know whether the pointing device 13 remains being turned on between sampling time t1 and t2 and between sampling time t2 and t3 according to the infrared lighting spot status signal within the wireless signal, the pointing device 13 can automatically draw lines to connect points (a1,b1) and (a2,b2), and connect points (a2,b2) and (a3,b3) when the infrared lighting spot status signal remains high. Of course, there also can be numerous sampling points between sampling time t2 and t3 so that the computer host 11 does not need to draw a line but these points, which are closely displayed, can be considered as a line.

During sampling time t3 to t4, the light emitting module 130 is turned off, and the computer host 11 can obtain such message because that each wireless signal transmitted between sampling time t3 to t4 has a infrared lighting spot status signal indicating the light emitting module 130 is disabled. Accordingly, the computer host 11 will not connect the points (a3,b3) and (a4,b4). And then, the computer host 11 will connect the points (a4,4) and (a5,b5) after identifying each wireless signal transmitted between sampling time t4 to t5 has a infrared lighting spot status signal indicating the light emitting module 130 is enabled.

To be noted, the pointing device 13 mentioned above can be a coaxial light source which can emit infrared light and visible light at the same time, and project the infrared light and the visible light at the same spot.

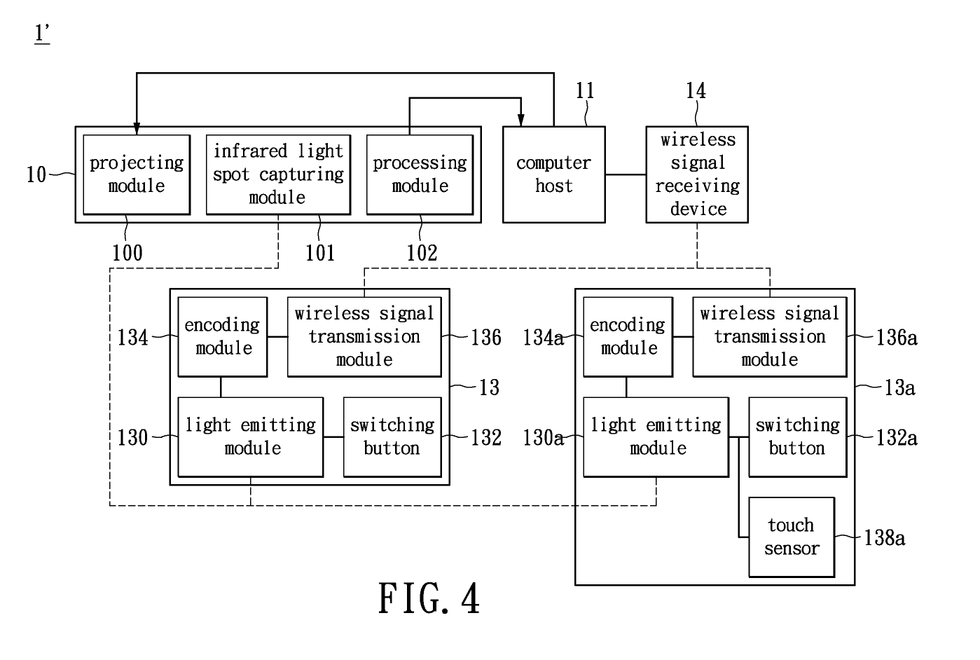

Please refer to FIG. 4, FIG. 4 shows a block diagram of the interactive projection system with light spot identification according to another embodiment of the present invention. As shown in FIG. 4, the interactive projection system with light spot identification 1′ includes a projector 10, a computer host 11, a screen 12, a pointing device 13, a pointing device 13a, and a wireless signal receiving device 14. The projector 10, the computer host 11, the screen 12, the pointing device 13, and the wireless signal receiving device 14 are substantially the same as the previous embodiment mention above.

To be noted, the pointing device 13a has a touch sensor 138a, the touch sensor 138a is coupled to the light emitting module 130a, and the touch sensor 138a can be disposed on one end of the pointing device 13a to determine whether the pointing device 13a touches a projection surface, such as a wall or the screen 12. And then, the pointing device 13a generates the infrared light when the touch sensor 138a is triggered.

Besides, the identification code of the pointing device 13 and the identification code of the pointing device 13a should be different so that the encoding module 134 and the encoding module 134a can combine the corresponded identification code and the corresponded infrared lighting spot status signal to generate a first wireless signal and a second wireless signal, respectively. The first wireless signal and the second wireless signal can be respectively received by the wireless signal transmission module 136 and the wireless signal transmission module 136a, and wirelessly transmitted to the wireless signal receiving device 14.

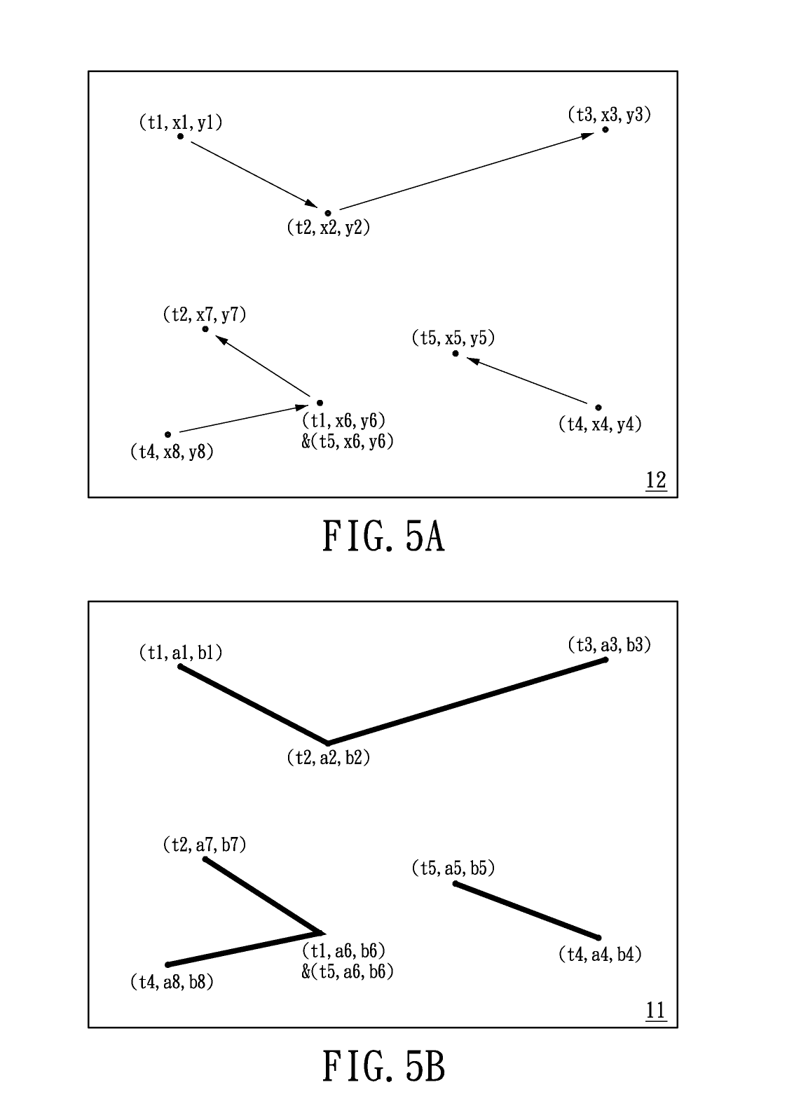

Please refer to FIG. 5A and FIG. 5B, FIG. 5A shows a diagram of infrared light spots moving on the screen according to another embodiment of the present invention, and FIG. 5B shows a diagram of the movement of infrared light spots displayed as an image signal within a computer host according to another embodiment of the present invention. As shown in FIG. 5A and FIG. 5B, when two infrared light spots appear at point (x1,y1) and point (x6,y6) at sampling time t1, the computer host 11 receives two wireless signals and the calculated coordinates indicating point (x1,y1) and point (x6,y6), and displays two different spots at point (a1,b1) and point (a6,b6) on the modified projection image. It is substantially the same process to draw lines corresponded to both pointing devices. In practice, because those two pointing devices are used by different users so that the pointing devices almost impossible to be turned on at the same time. Thus, the computer host 11 knows which pointing device is turned on firstly according to its identification code, and the computer host 11 keeps following the coordinates corresponded to the pointing device until the drawing is completed. Also, the computer host 11 can keep following the coordinates corresponded to the pointing device turned on secondly until the different drawing is completed. In practice, the computer host 11 can assign different colors or line shapes to different pointing devices, that the drawings inputted by different pointing devices can be displayed in different color or line shape, respectively.

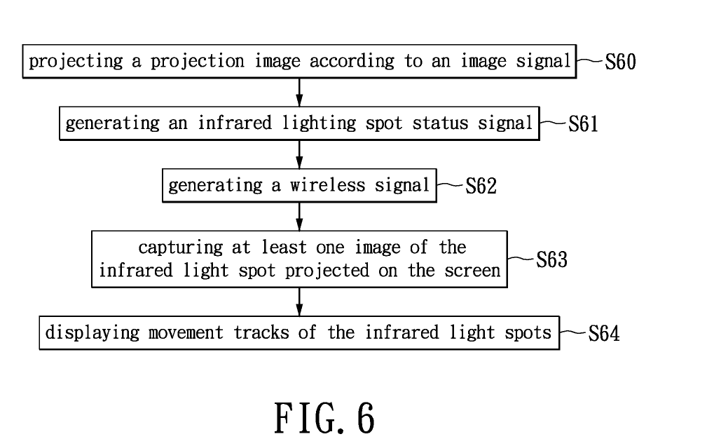

Please refer to FIG. 4 and FIG. 6, FIG. 6 shows a flowchart of a control method of the interactive projection system with light spot identification according to an embodiment of the present invention. The presented control method is used to identify at least one infrared light spot generated by at lest one pointing device. As shown in FIG. 4 and FIG. 6, in step S60, the image signal stored in the computer host 11, coupled to the projector 10, can be projected on the screen 12 to display the projection image via the projector 10. In step S61, the light emitting module 130 generates infrared light and outputs the infrared lighting spot status signal in response to the emission of the infrared light. In step S62, the encoding module 134 combines the identification code and the infrared lighting spot status signal to generate the wireless signal.

In step S63, the infrared light spot capturing module 101 of the projector 10 captures at least one image of the infrared light spot projected on the screen 12. In step S64, the computer host 11 displays the movement tracks of the infrared light spots on the screen 12 according to the images of the infrared light spot and the wireless signals.

Besides, in the step S63, the projector 10 further calculates at least one coordinate of the infrared light spot according to the image of the infrared light spot projected on the screen 12, which can be provided to the computer host 11 to calculate the movement tracks. In step S64, the computer host 11 can determine the pointing device 13 corresponded to the infrared light spot according to the wireless signal.

In addition, the pointing device 13 can have a switching button 132, the pointing device 13 generates the infrared light spot when the corresponded switching button 132 is triggered, or the pointing device 13a can have a touch sensor 138a, the pointing device 13a generates the infrared light spot when the corresponded touch sensor 138a contacts the screen 12.

To sum up, according to the embodiments of the present invention, each of pointing devices of the interactive projection system has an unique identification code so that the computer host can tell one infrared light spot from another, and movement tracks of infrared light spots emitted by the pointing devices can be calculated after capturing images of the infrared light spots projected on the screen. Besides, each of the infrared light spots can be processed by the computer host, respectively, so that the interactive projection system can be applied in multiple light spots interaction, thus the practicality of the interactive projection system is increased correspondingly.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. An interactive projection system with light spot identification, comprising:
M pointing devices, each of the M pointing devices comprising:
a light emitting module for selectively generating an infrared light spot, and generating an infrared lighting spot status signal corresponded to operating status of the light emitting module; and
a wireless signal transmission module for transmitting a wireless signal including an identification code and the infrared lighting spot status signal;
a projector comprising:
a projecting module for receiving an image signal of a computer host, and projecting a projection image on a screen according to the image signal; and
an infrared light spot capturing module for capturing at least one image of the infrared light spot projected on the screen; and
a wireless signal receiving device, coupled to the computer host, for receiving the wireless signal of each of the M pointing devices;
wherein the interactive projection system correspondingly displays movement tracks of the infrared light spots according to the image of the infrared light spot projected on the screen and the wireless signal of each of the M pointing devices, M is a positive integer greater than or equal to 1.

2. The interactive projection system with light spot identification according to claim 1, wherein the projector further comprises a processing module for calculating at least one coordinate of the infrared light spot according to the image of the infrared light spot projected on the screen.

3. The interactive projection system with light spot identification according to claim 2, wherein the computer host outputs the image signal to the projecting module, receives the coordinate of the infrared light spot and the wireless signal of each of the M pointing devices transmitted from the wireless signal transmission module, and determines the pointing device corresponded to the infrared light spot among the M pointing devices according to the wireless signal of each of the M pointing devices.

4. The interactive projection system with light spot identification according to claim 1, wherein at least one of the M pointing devices has a switching button, the pointing device generates the infrared light spot when the corresponded switching button is triggered.

5. The interactive projection system with light spot identification according to claim 1, wherein at least one of the M pointing devices has a touch sensor, the pointing device generates the infrared light spot when the corresponded touch sensor contacts the screen.

6. A control method of an interactive projection system with light spot identification for identifying at least one infrared light spot generated by at lest one pointing device, comprising following steps:
projecting a projection image according to an image signal;
generating an infrared lighting spot status signal corresponded to operating status of a light emitting module of the pointing device;
generating a wireless signal including an identification code of the pointing device and the infrared lighting spot status signal;
capturing at least one image of the infrared light spot projected on the screen; and
displaying movement tracks of the infrared light spots according to the image of the infrared light spot projected on the screen and the wireless signal.

7. The control method of an interactive projection system with light spot identification according to claim 6, wherein the step of capturing at least one image of the infrared light spot projected on the screen further comprises:
calculating at least one coordinate of the infrared light spot according to the image of the infrared light spot projected on the screen.

8. The control method of an interactive projection system with light spot identification according to claim 6, wherein the step of displaying movement tracks of the infrared light spots further comprises:
determining the pointing device corresponded to the infrared light spot according to the wireless signal.

9. The control method of an interactive projection system with light spot identification according to claim 6, wherein the pointing device has a switching button, the pointing device generates the infrared light spot when the corresponded switching button is triggered.

10. The control method of an interactive projection system with light spot identification according to claim 6, wherein the pointing device has a touch sensor, the pointing device generates the infrared light spot when the corresponded touch sensor contacts the screen.
